(19) United States
(12) Patent Application Publication
(10) Pub. No.: US 2003/0186044 A1
(43) Pub. Date: Oct. 2, 2003

(54) Cushioning made of flexible melamine foam and applications thereof

(76) Inventors: Jean Sauniere, Hossegor (FR); Agnes Timbre, Caussade (FR)

Correspondence Address: YOUNG & THOMPSON, 745 SOUTH 23RD STREET 2ND FLOOR, ARLINGTON, VA, 22202

(21) Appl. No.: 10/372,165

(22) Filed: Feb. 25, 2003

Related U.S. Application Data
(60) Provisional application No. 60/367,705, filed on Mar. 28, 2002.

(30) Foreign Application Priority Data
Feb. 25, 2002 (FR) 02.02368

(51) Int. Cl. B32B 3/26

(52) U.S. Cl. 428/315.7; 428/305.5; 428/315.9; 428/500; 428/68; 428/71; 428/76

(57) ABSTRACT

The invention concerns the application of a flexible melamine foam (7) having an indentation hardness stabilised to less than 300 N for 40% compression ratio, in the production of cushioning (2c, 3c, 4c). It also concerns items of upholstery (2a, 3a, 4a) for the seat base, back, headrest and legrest of a seat (1), and any other part of a seat, bed or any other element designed for comfort.

The present invention concerns the field of cushioning and upholstery for seats or beds.

Throughout the text, “upholstery” denotes any cushion or mattress forming part of a seat or bed, and adapted so as to provide comfort for a person called the occupant, resting on a covering directly or indirectly (for example via a detachable cover connected to the upholstery). Upholstery essentially comprises inner flexible cushioning determining its supporting properties, resilience, flexibility or hardness, durability and comfort, most often covered or enveloped by a flexible protective and/or decorative cover. Sometimes the upholstery also includes an element with a rigid structure such as a board receiving the cushioning.

In the field of the production of cushioning for the upholstery of seats or beds, flexible and elastic padding foams are conventionally used. Among the materials that are most used and most currently accepted, mention may be made of flexible open-cell polyurethane foams that are available in many varieties. Certain of these, by virtue of their mechanical properties, have up to now been able to meet normal comfort criteria correctly.

Generally, the flexible polyurethane foams that are particularly suited to such use have a density generally between 18 and 70 kg.m⁻³, a supporting capacity or compressive strength of 0.9 to 8 kPa (for 40% compression ratio) and a resilience situated between 15 and 25%. Normally, these three parameters (density, supporting ability and resilience) are considered as defining the level of comfort of a foam. However, degrees of supporting ability and resilience are more or less linked to the density.

The density of a foam defines the proportion of solid material and air. Now, in particular, the possibilities of air circulation within an open-cell foam directly influence comfort. The more air there is, the less material and the greater circulation and ventilation are facilitated.

The concept of supporting ability is a factor that is also important for ergonomic reasons and comfort. The greater the force necessary to compress the foam, the more the foam is said to be “supporting”. The supporting ability is also linked to the density. The less material there is, the less is the supporting ability. However, for a given density, a possible range of supporting ability exists.

A third important concept for comfort is elasticity. Elasticity is expressed by measurements of resilience and permanent set. Elasticity is also important for the aesthetics and firmness of cushioning with time. Indeed, the open-cell structure of polyurethane foams has a tendency with time to retain the deformation which it regularly undergoes, and a tendency of not returning to its initial shape through collapse and/or loss of height and supporting ability. Open-cell materials thus undergo a process of fatigue which gradually reduces their elastic properties until hard points are created in the region of hollows. The lower the density of a foam the more the ageing rate is accentuated.

Density thus appears as an essential parameter to be taken into account in the choice of a padding material. Up to now, it has been customary to consider that the production of cushioning requires the use of foams with a density much greater than 20 kg.m⁻³. Below this value, foams are considered to be unsuitable for this application. Moreover, and this is very important, the requirements of certain standards concerning the behaviour as regards fire, toxicity, heat emission, fume emission, dynamic fatigue, vibrational stresses etc, make it necessary to use specific materials, in particular polyurethane foams with a density varying between 40 and 70 kg.m⁻³. Since each field of application has its own requirements, this is the case in the field of motor vehicle seats and especially seats in aircraft for public or private transport.

Now, for various reasons, a reduction in the weight of cushioning is often sought, for example to facilitate transport and any conveyance of articles such as seats or beds, which are often already voluminous. Industrial fields are known in which the search for lightness is a continuing objective. Such is in particular the case in the field of personal transport (motor vehicle, railway and naval construction and especially aeronautical and space construction). In this field, any reduction in weight results in a considerable energy saving. Even more, the weight criterion for a vehicle is, apart from simple energy savings, often decisive in the sense that it governs the feasibility of the vehicle. In particular, in aeronautics and space travel it governs the ability of a machine to fly.

In addition, a real necessity exists to design cushioning with a lower density than those existing up to now, below 20 kg.m⁻³, which can however preserve an acceptable level of comfort and mechanical performance that is at least comparable to that of conventional cushioning.

Other flexible and elastic padding foams are known for cushioning, apart from open-cell polyurethane foams, for example neoprene, silicone, and polyethylene foams with a variable density, but one that is always much greater than 20 kg.m⁻³. Latex cushioning is also known with a density of approximately 65 kg.m³.

Document EP 0 121 049 is also known which describes reinforcing sheets made of melamine foam incorporated in cushioning. As EP 0 121 049 indicates, these sheets of melamine foam have a high compressive strength (reference is also made to indentation hardness), of the order of 400 N. These are therefore not flexible and elastic padding foams but rigid sheets. In EP 0 121 049, these sheets of melamine foam are used, not as a flexible padding material, but as inserts designed to modify specifically the particular properties of the padding foam used in the cushioning. More precisely, in EP 0 121 049, these sheets of rigid melamine foam act as a rigid reinforcing body for the purpose of improving the support of flexible padding foams as the need arises.

Melamine foams, in particular products designated by the trade name BASOTECT®, filed in the name of BASF, Germany, and foams obtained according to the manufacturing process described in U.S. Pat. No. 4,666,948, are open-cell duromer materials with a very low density, belonging to the group of aminoplasts. They are characterized by a combination of multiple properties: good acoustic and thermal insulation properties, fire behaviour providing good safety, high thermal stability, good chemical resistance to solvents and aggressive agents and excellent dimensional stability even in the case of permanent vibrations. These different types of performance explain the attention given to flexible melamine foams, in particular in the field of building construction, but also in high-technology fields such as automotive, railway and aeronautical construction etc., but exclusively in applications for acoustic absorption and thermal insulation.

These melamine foams are also characterized by a high compressive strength and very great weakness as regards tear and abrasion, and on account of this are unsuitable for the manufacture of cushioning.

The object of the present invention is to provide cushioning which, while having mechanical and physical properties (particularly comfort) comparable to those of previous cushioning materials, is distinguished from these by having a much lower weight.

To this end, the main object of the invention is to provide cushioning with mechanical and physical properties suitable for providing comfort at least equal to that of traditional open-cell polyurethane foam cushioning while having an appreciably lower density.

In particular, the object of the invention is to provide very light cushioning which retains its properties over time, both as regards its aesthetic appearance as well as its mechanical properties, namely cushioning capable of preserving the hardness and elasticity initially set by the manufacturer over a long period without any appreciable loss of height or supporting ability.

To this end, the present invention concerns cushioning characterized in that it comprises at least one portion of foam in the form of melamine foam with a hardness, measured in indentation according to ISO 2439 B Standard, below 300 N for 40% compression ratio, and called flexible melamine foam.

Throughout the text, the indentation measurements refer to measurements carried out in accordance with ISO 2439 B Standard.

Advantageously, and according to the invention, the said flexible melamine foam is a flexible melamine foam having a stabilised hardness of less than 300 N for 40% compression ratio, called stabilised flexible melamine foam.

A foam with a stabilised hardness of less than 300 N for 40% compression ratio is understood to mean a foam having, at this level of indentation, a hardness with a value below 300 N and one that is substantially constant with time (in particular around 25%, after 80,000 cycles of a dynamic fatigue procedure according to ISO 3385 Standard), and in particular during a dynamic fatigue procedure corresponding to its subsequent use.

Advantageously and according to the invention, the said flexible (in particular stabilised) melamine foam has a hardness of the order of 160 to 200 N for 40% compression ratio, in particular of the order of 180 N.

Advantageously and according to the invention, at least 50% (typically of the order of 60 to 70%) of the volume of the cushioning is formed of at least one portion of flexible (in particular stabilised) melamine foam. Accordingly, the portion(s) of flexible (in particular stabilised) melamine foam serve(s) as a flexible and elastic padding foam and constitute(s) the main part of the cushioning conferring thereon comfort properties. In any case, at least the core of the cushioning according to the invention is made of a flexible (in particular stabilised) melamine foam.

The present invention relies on the surprising discovery that traditional melamine foams which, by virtue of their high compressive strength and great weakness as regards tearing, were considered as unsuitable for the manufacture of cushioning, could however be used to produce a material with mechanical comfort and mechanical stability properties that are extremely advantageous for this particular application, on condition that they are previously subjected to a softening and/or stabilisation procedure, in particular by dynamic pre-fatigue. This pre-fatigue procedure consists of subjecting a material with a relatively high indentation hardness to successive compressions until a softer material is obtained having improved elasticity. Such a pre-fatigue process applied to a melamine foam makes it possible to generate a flexible melamine foam, possibly stabilised, with a hardness in indentation below 300 N for 40% compression ratio as previously quoted. Moreover, analyses of indentation properties, compressive strength, residual deformation, resilience, and an analysis of comfort and fatigue behaviour, etc., which up to now have never been performed on melamine foams, have made it possible to confirm that flexible (in particular stabilised) melamine foams according to the invention are perfectly suitable for the production of cushioning. In particular, comfort measurements have made it possible to demonstrate that flexible (in particular stabilised) melamine foam according to the invention advantageously has an indentation factor, according to ISO 2439 B Standard, much greater than 2.7 (in particular of the order of 5 to 7).

In this particular case, the inventors have been able to establish that a block of melamine foam, for example made of BASOTECT®, marketed by BASF, Germany, having undergone around twenty compression-decompression cycles, with a compression ratio of the order of 70%, has not only flexibility (indentation hardness below 300 N) and an elasticity comparable to those of a conventional flexible padding foam, but also highly improved mechanical stability, even greater than that of certain polyurethane foams.

Such a flexible (in particular stabilised) melamine foam is suitable most particularly for use as a flexible padding foam for cushioning. Apart from lightness and comfort at least comparable to those provided by an open-cell polyurethane foam, cushioning according to the invention including such a flexible melamine foam as a flexible padding material advantageously provides greater durability and wear resistance and in particular resistance to collapse (progressive loss of height and supporting ability with time and use).

It should be noted that EP 0 984 031 describes moulded articles formed of a sheet obtained by impregnating a porous material with a thermoplastic or thermosetting resin and a base made of a synthetic material. As a synthetic material, EP 0 984 031 quotes all the large families of synthetic materials: expanded plastics, wood or fibre conglomerates, plastic sheets, felts, nonwovens having a low boiling point, glass, wool, asbestos and similar materials. In one particular embodiment, EP 0 984 031 designates as an expanded plastic, expanded polyethylene and polypropylene and similar materials, polyvinyl chloride, polystyrene, melamine resin foams, urea resin foams, phenolic resin foams and similar materials. Among the diverse and varied applications for these moulded articles, EP 0 984 031 mentions, among others, the manufacture of wall panels, edging strips and similar products, cushions for seats and sofas and similar articles, interior materials and similar materials. EP 0 984 031 does not, in any case, teach a cushioning made of melamine foam, nor a foam having mechanical or physical properties comparable to those of a flexible (in particular stabilised) melamine foam, namely having been subjected to dynamic pre-fatigue such as previously indicated.

Advantageously and according to the invention, the density of the flexible (in particular stabilised) melamine foam is below 20 kg.m³, and is preferably situated between 8 and 12 kg.m³.

Advantageously and according to the invention, each portion made of flexible (in particular stabilised) melamine foam is at least partly protected by a material adapted so as to have a tear strength greater than that of flexible melamine foam.

Advantageously and according to the invention, at least one layer constituting the said cushioning is made of a flexible (in particular stabilised) melamine foam.

Advantageously, cushioning according to the invention comprises at least two distinct superimposed and assembled layers, of which at least one layer, referred to as the layer of distinct material, is made of a material other than a flexible melamine foam.

Advantageously and according to the invention, the layer(s) made of flexible (in particular stabilised) melamine foam represent(s) at least 50% of the thickness of the cushioning according to the invention, typically of the order of 60 to 70%.

Advantageously, a layer of distinct material according to the invention has a density above 20 kg.m⁻³.

Advantageously and according to the invention, at least one of the layers of an item of cushioning according to the invention has a pocketed structure over at least part of one of the faces of the said layer. Apart from a gradation of the hardness of the foam layer, this characteristic of the invention provides the possibility of a complementary weight reduction of the cushioning.

Advantageously, an item of cushioning according to the invention includes at least one layer made of a distinct material, referred to as the comfort layer, extending over a layer of flexible (in particular stabilised) melamine foam on the side of the occupant. This comfort layer may be a foam made of polyurethane and/or a visco-elastic material or any other suitable material.

Advantageously, cushioning according to the invention includes a layer of foam of a distinct material, referred to as the subjacent layer, extending from the side of the layer of flexible (in particular stabilised) melamine foam opposite the occupant, designed to adjust the overall supporting ability of the cushioning.

The different layers composing upholstery according to the invention may be assembled by various techniques depending on the materials used, such as for example by gluing or hot welding, techniques that are well-known to a person skilled in the art. It should of course be understood that any other process may be employed that makes it possible to obtain a durable bond between the layers.

The layers of material forming cushioning according to the invention may have different thicknesses and different densities. The respective thicknesses and densities of each of the cushioning layers are chosen according to the desired properties of the cushioning, and in particular its overall supporting ability and elasticity. The same applies to the shape and dimensions of the protuberances that define a pocketed material (layer of flexible melamine foam and/or the layer(s) of distinct material).

Advantageously and according to the invention, at least one insert extends over at least part of the thickness of the cushioning, in a particular location, designed to modify the mechanical properties as the need arises. Such an insert may for example be a polyurethane foam that is deformable in flexion and torsion, capable of deforming elastically so as to distribute the forces better. Such an insert may also be a visco-elastic foam or fluid blister or any other material capable of deadening vibrational and impact energy, for example by relieving certain sensitive parts of the body coming into contact with the surface of the upholstery.

Advantageously and according to the invention, the cushioning has a surface covering (forming, at least partly, one surface of the said cushioning).

Advantageously and according to the invention, the surface covering is chosen from a textile, leather and any other decorative covering.

Advantageously and according to the invention, the surface covering is fire-proofed.

The invention thus makes it possible to obtain cushioning which, apart from the desired qualities of support and elasticity suited to its use, has a very low weight compared with traditional cushioning. Also, cushioning according to the invention may advantageously be used for the production of upholstery for seats or beds having a low weight.

Accordingly, the invention concerns upholstery characterized in that it comprises at least one item of cushioning according to the invention covered at least partly with a protective and/or decorative flexible cover.

Such items of upholstery according to the invention are advantageously involved in the production of seats or beds where they enable the overall weight of these articles to be considerably reduced compared with former similar articles. Seats that are reduced in weight by virtue in particular of upholstery according to the invention may, advantageously and judiciously, take part in automotive, railway, aeronautical and space construction where any reduction in weight represents a considerable benefit.

The invention concerns a seat, in particular for a transport vehicle, having at least one constituent part (for example a seat base, a back, a headrest, a legrest, etc.) including at least one item of cushioning according to the invention. The invention thus extends to a seat characterized in that it includes at least one item of cushioning according to the invention.

The invention also concerns a seat characterized in that it includes at least one item of upholstery according to the invention.

Advantageously, a seat according to the invention is a seat for a transport vehicle chosen from: a car, coach, bus, train, underground train, tram, aircraft, ship, etc.

Generally, the invention extends to the use of a flexible (in particular stabilised) melamine foam having a hardness below 300 N for 40% compression ratio in indentation, in particular of the order of 160 to 200 N and preferably of the order of 180 N, as a flexible padding foam designed to enter into the composition of cushioning.

A flexible (in particular stabilised) melamine foam used according to the invention advantageously has a density below 20 kg.m⁻³, preferably situated between 8 and 12 kg.m⁻³.

Advantageously and according to the invention, this use represents at least 50% by volume of the said cushioning.

The invention also concerns cushioning, a cushion, a seat and a use of a flexible (in particular stabilised) melamine foam with a hardness below 300 N for 40% compression ratio in indentation, as a flexible padding foam designed to enter into the composition of cushioning, characterised in combination, by all or part of the characteristics stated above or below.

Other objectives, characteristics and advantages of the invention will become apparent on reading the following examples which refer to the accompanying figures, in which:

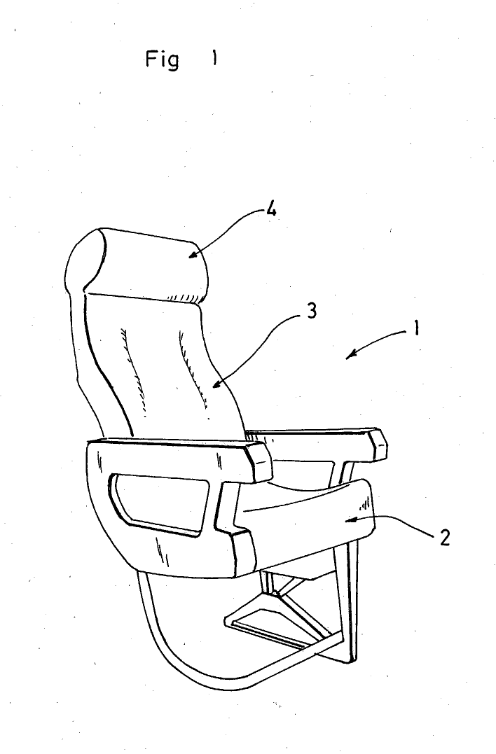

FIG. 1 is an overall diagrammatic perspective view of a passenger seat of an airliner, provided with a seat base, a back, a headrest and two armrests that are equipped with cushioning and upholstery according to the present invention,

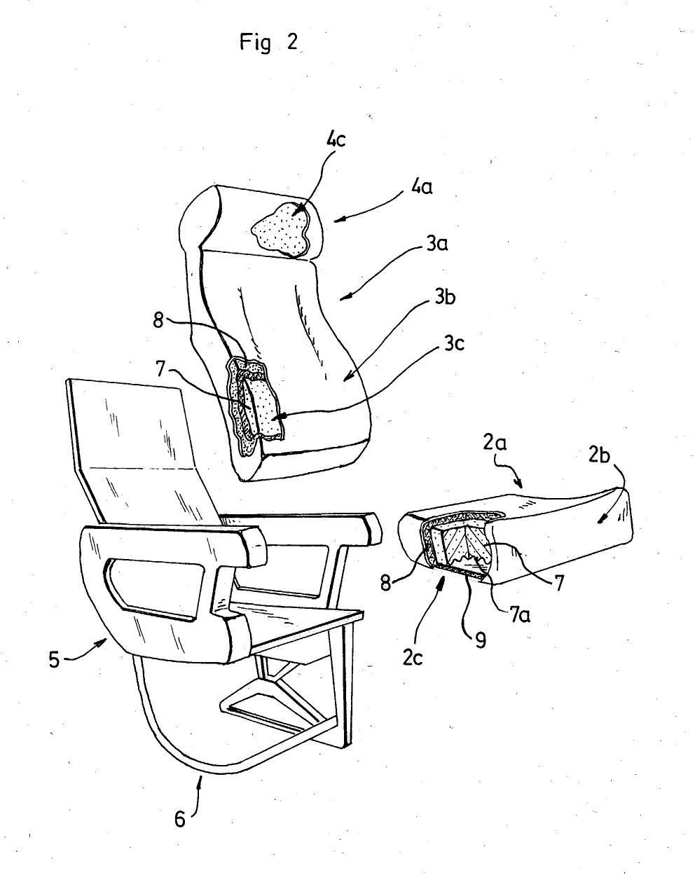

FIG. 2 is an exploded perspective diagrammatic view, with parts removed, of a passenger seat on an aircraft according to the present invention, revealing the structure of the cushioning,

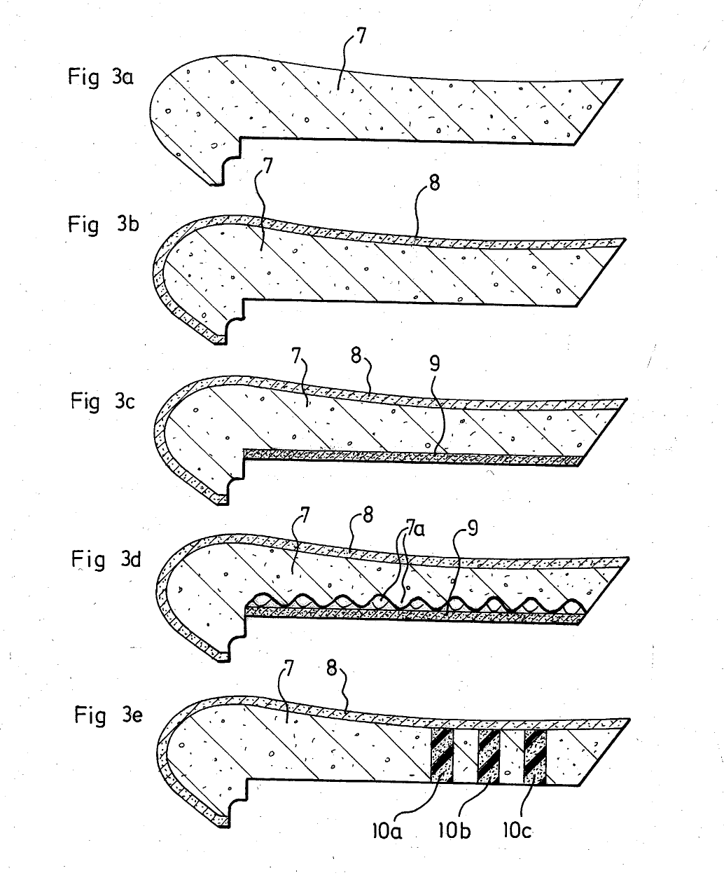

FIGS. 3a, 3b, 3c, 3d and 3e are sectional diagrammatic views through a longitudinal vertical plane, representing five variants of cushioning for the upholstery of the seat base of seats, in particular passenger seats of an airliner,

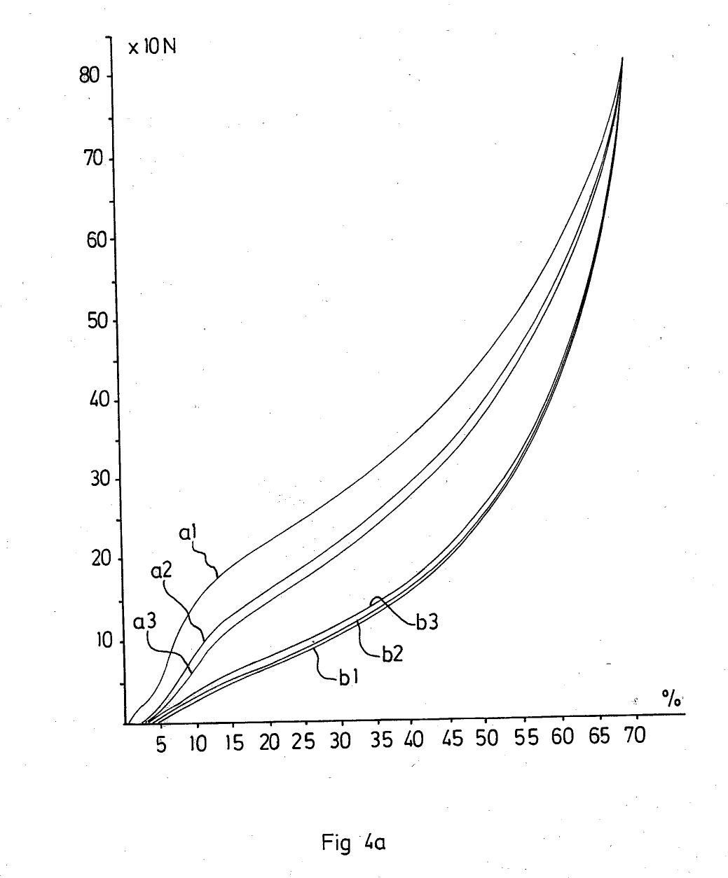

FIGS. 4a and 4b are graphical representations of variations of the indentation of a melamine foam as a function of the number of compression-decompression cycles during a pre-fatigue procedure according to the invention,

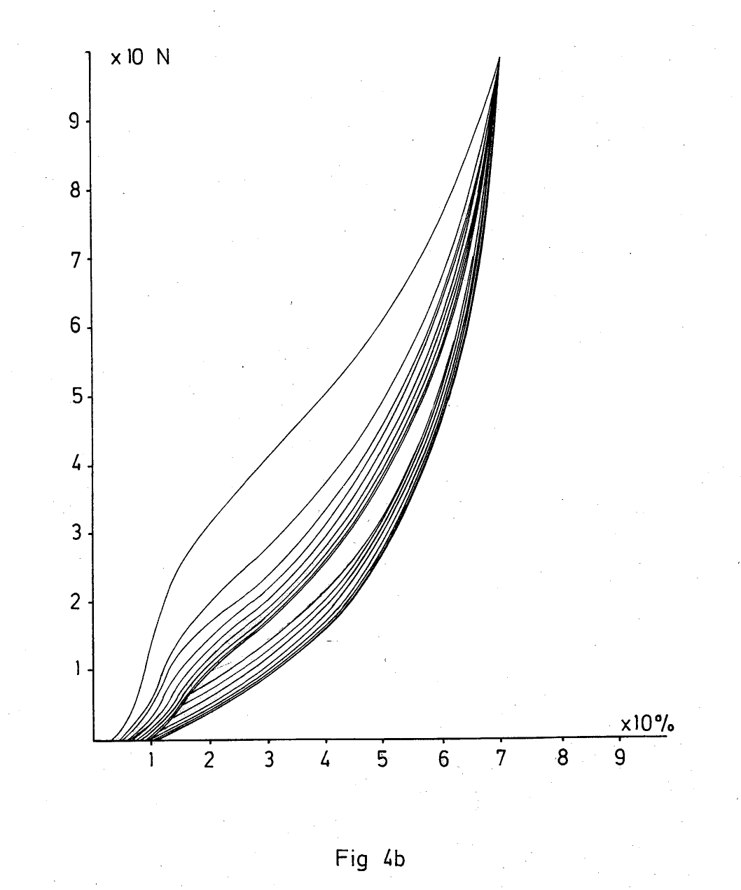

FIG. 5 is a representation of variations of the resistance at 40% indentation of a melamine foam subjected to a pre-fatigue procedure according to the invention,

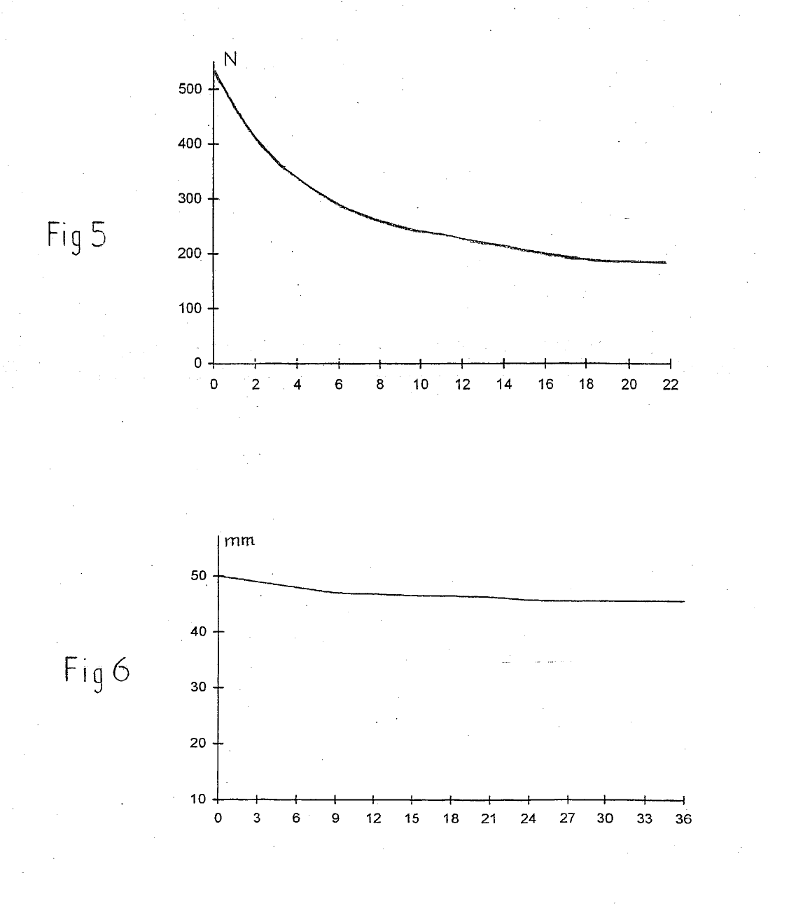

FIG. 6 is a representation of changes to the height of a block made of melamine foam subjected to a pre-fatigue procedure according to the invention.

A first step in the manufacture of cushioning according to the invention consists of obtaining a flexible padding material from a melamine foam. In a non-limiting manner, it may consist of a block of melamine foam in accordance with a product designated by the trade name BASOTECT® in the name of BASF, Germany.

The said block of melamine foam is subjected to a prefatigue process so as to modify certain of its mechanical properties, in particular hardness and elasticity.

To this end, the pre-fatigue procedure consists of exerting a series of compressions on the block of melamine foam interrupted by decompression phases at a degree of compression of 70% indentation and at a rate, for example, of the order of 500 mm.mn⁻¹.

Regularly, during the pre-fatigue procedure, samples of melamine foam were taken in different parts of the block to be converted. For these different samples, the level of comfort, indentation hardness and elasticity were evaluated by means of indentation measurements carried out according to ISO 2439 B Standard and compressive strength (at 25%, 40% and 65% of compression ratio) according to ISO 3386 Standard. The results are shown in graphical form in FIGS. 4a, 4b and 5.

FIGS. 4a and 4b correspond to indentation readings for a melamine foam of the BASOTECT® type, during a pre-fatigue procedure. The compression or reactive decompression force is shown on the ordinate axis and the degree of indentation is represented on the abscissa axis.

FIG. 4a shows indentation readings for the BASOTECT® foam, as marketed, during the first three compression-decompression cycles. Curves a₁ a₂ and a₃ correspond to the compression forces respectively of the initial foam, and of the foam at the second and third compression-decompression cycles. Curves b₁, b₂ and b₃ relate to the corresponding reactive pressures.

FIG. 4b shows the first twenty compression-decompression cycles for the BASOTECT® foam, as marketed.

As these two figures show, the BASOTECT® foam, with an initial hardness of the order of 500 N for 40% compression ratio, undergoes softening due to modification of the cells right from the first compressions.

Softening occurs in a progressive manner to reach a flexibility state having high stability after about twenty cycles. During this phase in the pre-fatigue procedure, the melamine foam that has become flexible undergoes progressive stabilisation until it reaches, after approximately twenty pre-fatigue cycles, a high stability both as regards flexibility as well as elasticity. FIG. 5 showing the results of the analysis of strength at 40% compression ratio illustrates this stabilising effect. The indentation force exerted at 40% is shown on the ordinate axis and the number of cycles on the abscissa axis.

A melamine foam of the BASOTECT® type having been subjected to a pre-fatigue procedure according to the invention, advantageously with approximately twenty cycles, then has a hardness stabilised at around 180 N in indentation for 40% compression ratio. This indentation value reflects a high level of comfort equivalent to, or even greater than, the level of comfort of many padding foams used up to now.

Cushioning according to the invention, using a melamine foam modified in this way, known as a flexible (in particular stabilised) melamine foam, thus not only has flexibility and comfort at least equivalent to those of cushioning incorporating a traditional flexible padding foam, but also a significantly lower density as well as an extremely stable level of hardness and elasticity, and accordingly great durability and resistance to the collapse phenomenon. In particular, tests according to ISO 3385 Standard have made it possible to show that such a flexible melamine foam, stabilised according to the invention, suffered a loss of hardness less than 25%, typically of the order of 19.5%, after 80,000 cycles at 75 daN.

FIG. 6 enables changes to the reduction in height of the block of melamine foam to be followed throughout the prefatigue procedure. The height of the melamine foam specimen is shown on the ordinate axis and the number of cycles on the abscissa axis. FIG. 6 demonstrates the stability of the height of a block of flexible melamine foam modified in this way and also makes it possible to define the size of the melamine foam block to be used with a view to obtaining exactly the desired height of the flexible (in particular stabilised) melamine foam in terms of a pre-fatigue procedure with a well-defined number of cycles.

Once the melamine foam has been converted, softened and/or stabilised, this can then be used as any other flexible padding foam suitable for the production of cushioning.

Although the following examples and the corresponding figures relate to cushioning for the upholstery of a passenger seat in an airliner for which the invention provides particular and definite advantages, the invention is not limited to these items of cushioning with a particular structure, nor to passenger seats of an airliner having these types of cushioning. The aim of these examples is only to propose various structures that can be envisaged for cushioning incorporating a flexible (in particular stabilised) melamine foam according to the invention.

FIGS. 1 and 2 show a passenger seat 1 of an airliner consisting of a seat base 2 supporting a back 3, surmounted by a headrest 4, upholstery 2a, 3a and 4a, of the seat base 2, back 3 and head-rest 4 respectively, resting on a rigid frame 5 of the seat 1.

The assembly of the seat 1 is fixed to the floor of the aircraft by the feet 6 which are extensions of the rigid frame 5 of the seat 1.

These items of upholstery 2a, 3a and 4a themselves consist of items of cushioning 2c, 3c and 4c covered by flexible protective covers 2b, 3b and 4b. The items of cushioning 2c, 3c and 4c can be single blocks 4c of flexible (in particular stabilised) melamine foam or assemblages 2c and 3c of padding materials including at least one portion of flexible (in particular stabilised) melamine foam 7. Different methods for producing cushioning according to the invention are shown in a non-limiting manner in FIGS. 3a, 3b, 3c, 3d and 3e.

In the first embodiment shown in FIG. 3a, the cushioning 2c consists of a single block of flexible (in particular stabilised) melamine foam 7 having a shape adapted so that the upholstery 2a of the seat base 2 can be put in place simply and rapidly onto the rigid frame 5 of the seat 1. This single block is made of a flexible melamine foam 7, conforming to BASOTECT® marketed by BASF, Germany and modified according to the invention by means of a prefatigue procedure. The shape given to the cushioning can be produced by thermoforming, hot-pressing, cutting or moulding.

In a second embodiment, shown in FIG. 3b, the cushioning 2c has a bilayer structure. The layer of flexible (in particular stabilised) melamine foam 7, having a shape comparable to the single-block cushioning shown in FIG. 3a, is covered on its upper surface with a layer of distinct material 8 which can be a comfort foam capable of providing the user with better comfort. Advantageously, it consists of a visco-elastic and/or polyurethane foam having low resilience, adapted so as to distribute the weight of the user more satisfactorily, attenuating in this way local pressures. To this end, it is possible to insert, at the time of moulding, a cut-off of flexible (in particular stabilised) melamine foam coming from a block, inside a moulded part made of polyurethane or latex.

Instead of being a layer of comfort foam, the layer of distinct material 8 may be a covering, for example fireproofed, or alternatively a protective layer made of a material adapted so as to have a tear strength greater than that of the flexible (in particular stabilised) melamine foam.

This cushioning, according to another variant of the invention, may also have, as shown in FIG. 3c, a layer of foam of a distinct material 9 subjacent to the layer of flexible (in particular stabilised) melamine foam 7, providing for example better supporting ability to all its structure on the frame 5. It will then consist for example of a layer of foam made of polyurethane or any other material with a suitable density and thickness.

In a fourth embodiment shown in FIG. 3d, the cushioning of the seat base cushion has a multilayer structure comparable to the cushioning of FIG. 3c, but the layer of flexible (in particular stabilized) melamine foam 7 is provided, on part of its lower surface, with a pocketed structure 7a formed of a plurality of protuberances separated from each other by reinforcements.

This pocketed structure 7a, apart from allowing extra reduction in weight to be achieved, makes it possible to obtain the desired flexibility for the cushioning through a suitable choice of the shape of the protuberances and/or reinforcements and their distribution.

Very many variants may be envisaged according to the invention. The protuberances project from at least one face of the flexible (in particular stabilised) melamine foam 7, preferably perpendicular overall to the said face, and parallel overall to each other. They may have more or less pointed and conical shapes of various sizes, with bases of varying width, having a variable distribution density etc. The same applies to the reinforcements between the protuberances.

According to another embodiment, shown in FIG. 3e, the structure of the cushioning may include various inserts 10a, 10b and 10c which may be positioned, within the thickness defined by the layer of flexible (in particular stabilised) melamine foam 7, in particular zones of the cushioning. These inserts may, for example, make it possible to obtain modified mechanical properties in these zones, in particular resilience, elasticity or supporting ability. Such inserts may extend over all the thickness of the cushioning 2c or only over part of this thickness. They may be formed of springs, fluid blisters (air, gels, liquids etc) or of a material such as a foam made of polyurethane, neoprene, silicone, polyethylene, or a combination of such materials. Whatever the case may be, the comfort properties of the cushioning are essentially derived from each portion of flexible melamine foam which is adapted, in particular as regards its shape and position within the cushioning, with this aim in mind.

1. Cushioning, wherein it comprises at least one portion of foam formed of a melamine foam with a hardness, measured in indentation, according to ISO 2439 B Standard below 300 N for 40% compression ratio and called flexible melamine foam.

2. Cushioning as claimed in claim 1, wherein the said flexible melamine foam is a flexible melamine foam with a hardness stabilised to less than 300 N for 40% compression ratio, called stabilised flexible melamine foam.

3. Cushioning as claimed in either of claims 1 or 2, wherein the said flexible melamine foam has a hardness of the order of 160 to 200 N for 40% compression ratio.

4. Cushioning as claimed in one of claims 1 to 3, wherein the said portion of flexible melamine foam has a hardness of the order of 180 N for 40% compression ratio.

5. Cushioning as claimed in one of claims 1 to 4, wherein at least 50% of its volume is formed of at least one portion of flexible melamine foam.

6. Cushioning as claimed in one of claims 1 to 5, wherein the flexible melamine foam has a density below 20 kg.m⁻³.

7. Cushioning as claimed in claims 1 to 6, wherein the flexible melamine foam has a density of between 8 and 12 kg.m⁻³.

8. Cushioning as claimed in one of claims 1 to 7, wherein each portion made of flexible melamine foam (7) is at least partly protected by a material adapted so as to have a tear resistance greater than that of the flexible melamine foam.

9. Cushioning as claimed in one of claims 1 to 8, wherein at least one layer constituting the cushioning is made of a flexible melamine foam (7).

10. Cushioning as claimed in one of claims 1 to 9, wherein it comprises at least two distinct superimposed and assembled layers, of which at least one layer, referred to as the layer of distinct material (8, 9), is made of a material other than a flexible melamine foam.

11. Cushioning as claimed in one of claims 1 to 10, wherein the layer(s) made of flexible melamine foam (7) represent(s) at least 50% of the thickness of the said cushioning.

12. Cushioning as claimed in either claim 10 or 11, wherein the layer(s) of distinct material (8, 9) has/have a density or densities greater than 20 kg.m⁻³.

13. Cushioning as claimed in one of claims 9 to 12, wherein at least one of the layers of the said cushioning has a pocketed structure (7a) over at least part of one of the faces of the said layer.

14. Cushioning as claimed in one of claims 10 to 13, wherein it includes at least one layer of distinct material, referred to as the comfort layer, extending over one layer of flexible melamine foam on the side of the occupant.

15. Cushioning as claimed in claim 14, wherein the comfort layer is made of a material chosen from a polyurethane foam or a visco-elastic material.

16. Cushioning as claimed in one of claims 10 to 15, wherein it includes at least one layer of distinct material, referred to as the subjacent layer (a), extending from the side of the layer of flexible melamine foam (7) opposite the occupant, and designed to adjust the overall supporting ability of the said cushioning.

17. Cushioning as claimed in one of claims 1 to 16, wherein it includes at least one insert (10a, 10b, 10c) extending over at least part of the thickness of the cushioning designed to modify its mechanical properties as required.

18. Cushioning as claimed in one of claims 1 to 17, wherein it has a surface covering.

19. Cushioning as claimed in claim 18, wherein the surface covering is chosen from a textile, leather or any other decorative covering.

20. Cushioning as claimed in claim 18 or 19, wherein the surface covering is fire-proofed.

21. Seat upholstery (2a, 3a, 4a) wherein it includes at least one item of cushioning as claimed in one of claims 1 to 20 at least partly covered with a flexible protective and/or decorative cover (2b, 3b, 4b).

22. Seat (1) wherein it includes at least one item of cushioning as claimed in one of claims 1 to 20.

23. Seat (1) wherein it includes at least one item of upholstery as claimed in claim 21.

24. Use of a flexible (in particular stabilised) melamine foam with an indentation hardness of below 300 N for an indentation of 40%, as a flexible padding foam designed to enter into the composition of an item of cushioning.

25. Use of a flexible melamine foam as claimed in claim 24, wherein the said flexible melamine foam has a density below 20 kg.m³.

26. Use of a flexible melamine foam as claimed in claim 24 or 25, wherein the flexible melamine foam has a density of between 8 and 12 kg.m⁻³.

27. Use of a flexible melamine foam as claimed in one of claims 24 to 26, wherein it represents at least 50% by volume of the said cushioning.
